(19) United States
(12) Patent Application Publication
(10) Pub. No.: US 2003/0031215 A1
(43) Pub. Date: Feb. 13, 2003

(54) Compound light source employing passive Q-switching and nonlinear frequency conversion

(76) Inventors: Thomas J. Kane, Menlo Park, CA (US); Mark A. Arbore, Los Altos, CA (US)

Correspondence Address: MAREK ALBOSZTA, LUMEN INTELLECTUAL PROPERTY SERVICES, SUITE 110, 45 CABOT AVENUE, SANTA CLARA, CA, 95051, US

(21) Appl. No.: 09/927,145

(22) Filed: Aug. 10, 2001

(51) Int. Cl. H01S 3/11

(52) U.S. Cl. 372/10

(57) ABSTRACT

A light source employing a passively Q-switched laser, a fiber amplifier and a nonlinear element for performing single pass frequency conversion to generate a pulsed output beam. The Q-switched laser delivers a pulsed primary beam at a primary wavelength which is amplified by fiber amplifier to produce a pulsed intermediate beam containing pulses at the primary wavelength. The Q-switched laser is configured such that these pulses have a certain format. Specifically, these pulses have a format corresponding to a certain frequency conversion efficiency, preferably higher than 10% or even higher than about 50% in single pass frequency conversion performed by the nonlinear element. The nonlinear element includes one or more nonlinear crystals for performing a single or cascaded nonlinear conversion operations. Depending on the application of the light source, the primary wavelength range can be chosen between 860 nm and 1100 nm and the output wavelength can range from 430 nm to 550 nm. This output wavelength range covers blue and green wavelengths.

### FIELD OF THE INVENTION

The present invention relates generally to compound light sources employing lasers with passive Q-switches and nonlinear frequency converters to generate light in the desired wavelength range.

### BACKGROUND OF THE INVENTION

Many applications require reliable, stable and efficient spectrally-pure high-power light sources. For example, projection display systems require light sources which exhibit these characteristics and deliver in excess of 1 Watt average power. These light sources should be inexpensive to produce and they need to generate output frequencies in the blue range and in the green range. For other applications light in the UV range is required.

The prior art teaches various types of light sources for generating light in the visible and UV ranges, including frequencies corresponding to blue and green light. A number of these sources rely on a nonlinear frequency conversion operation such as second harmonic generation (SHG) to transform a frequency outside the visible range, e.g., in the IR range, to the desired visible or UV frequency. For example, U.S. Pat. No. 5,751,751 to Hargis et al. teaches the use of SHG to produce deep blue light. Specifically, Hargis et al. use a micro-laser which has a rare earth doped microlaser crystal and emits light at about 914 nm to drive SHG in a crystal of BBO producing output at about 457 nm.

U.S. Pat. No. 5,483,546 to Johnson et al. teaches a sensing system for high sensitivity spectroscopic measurements. This system uses a passively Q-switched laser emitting light at a first frequency. The light from the laser is transmitted through a fiber and converted to output light at a second frequency in the UV range. The conversion is performed by two frequency doubling crystals disposed far away from the Q-switched laser.

U.S. Pat. No. 6,185,236 to Eichenholz et al. teaches a self frequency doubled Nd:doped YCOB laser. The laser generates light of about 400 mW power at about 1060 nm and frequency doubles it with the aid of a frequency doubling oxyborate crystal to output light in the green range at about 530 nm. Eichenholz et al. combine the active gain medium and the frequency doubler in one single element to produce a compact and efficient light source.

In U.S. Pat. No. 5,909,306 Goldberg et al. teach a solid-state spectrally pure pulsed fiber amplifier laser system for generating UV light. This system has a fiber amplifier in a resonant cavity and an acousto-optic or electro-optic modulator incorporated into the cavity for extracting high-peak-power, short-duration pulses from the cavity. These short pulses are then frequency converted in several non-linear frequency conversion crystals (frequency doubling crystals). The addition of the modulator into the cavity for extracting the pulses and placement of the fiber amplifier within the resonant cavity renders this system very stable and capable of delivering a spectrally-pure pulse. Unfortunately, this also makes the system too cumbersome and expensive for many practical applications such as display systems.

U.S. Pat. No. 5,740,190 to Moulton teaches a three-color coherent light system adapted for image display purposes. This system employs a laser source and a frequency doubling crystal to generate green light at 523.5 nm. Moulton's system also generates blue light at 455 nm and red light at 618 nm by relying on frequency doubling and the nonlinear process of optical parametric oscillation.

Unfortunately, the light sources described above and various other types of light sources taught by the prior art can not be employed to make stable, low-cost, efficient sources of light delivering 1 Watt of average power for display applications. This is in part due to the fact that frequency conversion, e.g., frequency doubling in crystals, is not a very efficient operation. If the frequency doubling crystal had extremely high non-linearity, then low power continuous wave (cw) lasers could be efficiently doubled to generate output power levels near 1 Watt. However, in the absence of such frequency doubling crystals high-peak-power, short pulse lasers have to be used to obtain frequency doubled light at appreciable power levels. It should also be noted that providing such high-peak-power short pulses adds complexity to the design of the light sources and introduces additional costs.

U.S. Pat. No. 5,394,413 to Zayhowski addresses the issue of efficient frequency doubling by using a passively Q-switched picosecond microlaser to deliver the pulses of light. Such pulses can be efficiently converted, as further taught by Zayhowski in a frequency-doubling crystal. Devices built according to Zayhowski's teaching operate at relatively low average power levels and low repetition rates. Attempts to increase these parameters by pumping the microchip harder will cause multiple transverse-mode operation leading to degradation of beam quality and also incur increased pulse-to-pulse noise. Hence, Zayhowski's devices can not be used in applications such as projection displays, which require high average power and high repetition rates and good beam quality

Hence, what is needed is a stable and efficient source of light in the blue and green ranges which can be used in a projection display.

### OBJECTS AND ADVANTAGES

It is therefore a primary object of the present invention to provide a stable, low-cost and efficient light source generating light in the blue and green ranges at an average power output of 1 Watt or more.

It is another object of the invention to adapt such light source to image display systems, and in particular to scanned linear projection displays.

These and other objects and advantages of the invention will become apparent upon further reading of the specification.

### SUMMARY

The objects and advantages are achieved by a light source employing a passively Q-switched laser for delivering a pulsed primary beam at a primary wavelength. The light source has a fiber amplifier for receiving the primary beam and amplifying it to produce a pulsed intermediate beam. The intermediate beam contains pulses at the primary wavelength. The Q-switched laser is configured such that these pulses have a certain format. Specifically, these pulses have a format corresponding to a certain frequency conversion efficiency, preferably higher than 10% or even higher than about 50%. The light source is further equipped with a nonlinear element for frequency converting the pulsed intermediate beam in a single pass at the conversion efficiency determined by the pulse format to produce a pulsed output beam at an output wavelength.

Depending on the application of the light source, the primary wavelength range can be chosen between 860 nm and 1100 nm and the output wavelength can range from 430 nm to 550 nm. This output wavelength range covers blue and green wavelengths useful, e.g., in image displays.

In a preferred embodiment the fiber amplifier is a cladding-pumped amplifier. The core section and cladding section of the cladding pumped amplifier can be chosen to have suitable shapes and dimensions for efficient amplification of the primary beam. Furthermore, the length of cladding-pumped amplifier is preferably limited to less than 2 m.

The passively Q-switched laser is preferably equipped with a saturable absorber Q-switch. In order to generate intermediate pulses of appropriate format, i.e., above the nonlinear frequency conversion threshold, the Q-switch is set such that the pulsed primary beam has primary pulses with a duty cycle ranging from 0.01% to 1%. The Q-switch is also set such that the primary pulses have a certain pulse width and the interpulse separation between them is at least 100 times the pulse width. Furthermore, the Q-switch is also set to operate the passively Q-switched laser at a primary pulse repetition rate of at least 100 kHz.

The nonlinear element can be made up of one or more nonlinear optical crystals. For example, the nonlinear element can consist of one or more crystals from the borate family. Specifically, LBO or BBO crystals can be used as the nonlinear element.

In a preferred embodiment the light source of the invention is used in a display system. Once again, the light source is equipped with the passively Q-switched laser for delivering the pulsed primary beam consisting of primary pulses at the primary wavelength and a fiber amplifier for receiving and amplifying the primary beam. The nonlinear element is positioned to receive the intermediate beam produced by the fiber amplifier and to frequency convert it in a single pass to produce the output beam at the output wavelength.

The display system has a plurality of display pixels for displaying a projected image. The display pixels are refreshed at a refresh rate. A synchronizing mechanism is provided for synchronizing output pulses of the pulsed output beam with the refresh rate. In a preferred embodiment, the synchronizing mechanism synchronizes the pulses with the refresh rate such that the output pulse rate is an integer multiple of the refresh rate.

As will be apparent to a person skilled in the art, the invention admits of a large number of embodiments and versions. The below detailed description and drawings serve to further elucidate the invention.

### BRIEF DESCRIPTION OF THE FIGURES

FIG. 1 is a diagram of a light source according to the invention.

FIG. 2 is a timing diagram illustrating pulse timing in the light source of FIG. 1.

FIG. 3A is a detailed cross sectional view of a particular Q-switched laser suitable for use in a light source according to the invention.

FIG. 3B is a diagram of another Q-switched laser suitable for use in a light source according to the invention.

FIG. 4A&B are cross sectional views of fiber amplifiers suitable for use in a light source of the invention.

FIG. 5 is a diagram of another embodiment of a light source according to the invention.

FIG. 6 is an isometric view of a display system in accordance with the invention.

FIG. 7 is a plan view of a pixel in the display system of FIG. 6.

FIG. 8 is a timing diagram illustrating the synchronization of the refresh rate with the pulse rate.

### DETAILED DESCRIPTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

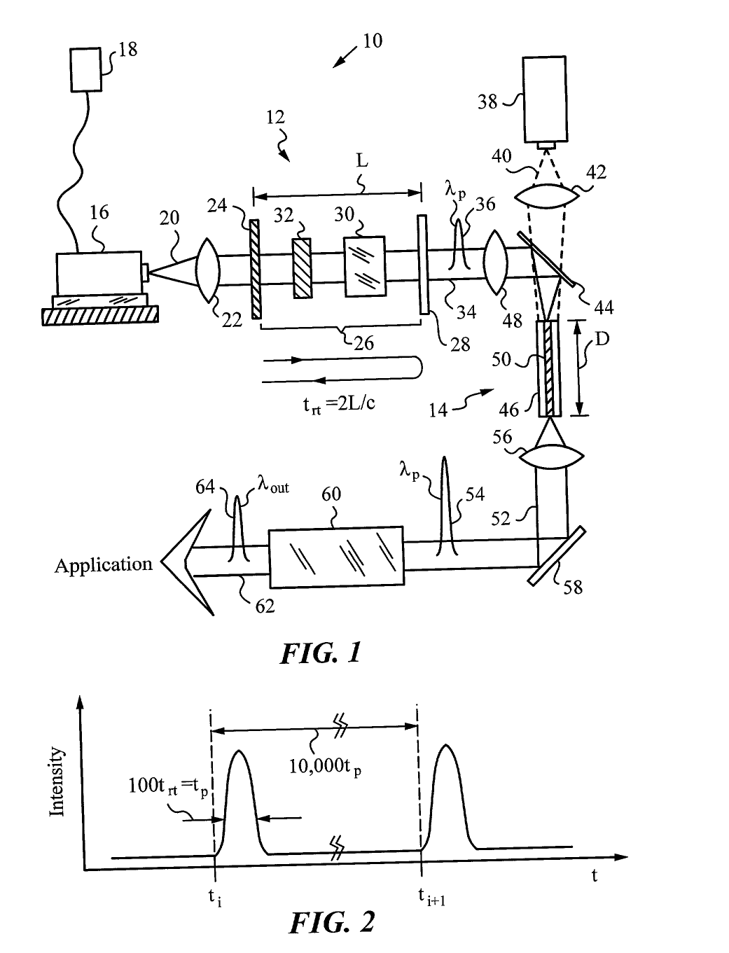

FIG. 1 illustrates a light source 10 with a passively Q-switched laser 12 and a fiber amplifier 14 according to the invention. Light source 10 has a pump source 16 for producing pump light 20. In this embodiment, pump source 16 is a laser equipped with a wavelength tuning mechanism 18. Laser 16 is designed to deliver pump light 20 in the form of a continuous wave (cw) light beam. Many types of lasers are suitable for use as pump source 16. For example, diode lasers emitting pump light 20 within the 750 nm to 1100 nm range can be used. The power level of these diode lasers can be between 100 mW and 4000 mW.

A lens 22 is provided before pump source 16 for focusing pump light 20 and directing it to an input coupler 24 of Q-switched laser 12. Input coupler 24 is designed to admit pump light 20 into a cavity 26 of passively Q-switched laser 12. Cavity 26 has a length L defined between input coupler 24 and an output coupler 28. Although in the present embodiment cavity 26 is linear and couplers 24, 28 are in the form of mirrors, a person skilled in the art will appreciate that other types of cavities and coupling elements can be used.

Cavity 26 contains a gain medium 30. Gain medium 30 exhibits a high amount of gain per unit length when pumped with pump light 20. Typically, high gain is achieved by providing a high doping level in gain medium 30 within the cross section traversed by light 20. Doped materials with suitable amounts of gain to be used as gain medium 30 include Yb:YAG at the 1030 nm and 980 nm transitions, Nd:Vanadate at the 880 nm, 914 nm, and 1064 nm transitions and Nd:YAG at the 946 nm and 1064 nm transitions. A person skilled in the art will be familiar with other suitable materials and the corresponding transitions. Some of these materials include Yb Glass Fiber (980 nm transition), Yb Glass Fiber (1020-1120 nm transition), Nd Glass Fiber (880-940 nm transition), and Nd Glass Fiber (1050-1090 nm transition).

Cavity 26 also contains a passive variable loss element or passive Q-switch 32. Preferably, passive Q-switch 32 is a saturable absorber Q-switch such as chromium:YAG, which functions in the wavelength range from 860 nm to 1100 nm. Alternatively, semiconductors or semiconductor material structured to act as a mirror can be used as passive Q-switch 32. Passive Q-switch 32 is adjusted for switching on and off such that, when subjected to cw pumping by pump light 20, passively Q-switched laser 12 generates a pulsed primary beam 34 at a primary wavelength λₚ. For clarity, only a single primary pulse 36 of primary beam 34 exiting cavity 26 through output coupler 28 is indicated in FIG. 1. Primary wavelength λₚ corresponds to the selected transition of gain medium 30. This transition can be selected in any suitable range. In the present case, the transitions are selected in a wavelength range between 860 nm and 1100 nm.

Light source 10 also has a pump source 38 for supplying a pump light 40. Source 38 can be a diode laser operating in the wavelength range from 750 to 1000 nm and delivering between 1 and 100 Watts of power. Preferably, source 38 is fiber coupled laser such as a LIMO type laser (available from LIMO Laser Systems, laser@limo.de). A lens 42 and a beam combiner 44 are positioned in the path of pump light 40. Lens 42 focuses pump light 40 such that it is in-coupled into fiber amplifier 14. In particular, with the aid of lens 42 pump light 40 is in-coupled into a cladding 46 of fiber amplifier 14. A lens 48 is also positioned in the path of primary beam 34 before beam combiner 44. Lens 48 focuses primary beam 34 such that after being combined with pump light 40 by beam combiner 44, primary beam 34 is in-coupled into a core 50 of fiber amplifier 14.

Fiber amplifier 14 produces a pulsed intermediate beam 52 at primary wavelength λₚ from primary beam 34. Preferably, pulsed intermediate beam 52 exhibits high peak power, e.g., in the range of 10,000 Watts in each pulse 54 (only one pulse shown for reasons of clarity). To achieve such high peak power fiber amplifier 14 has a short length D, e.g., D is on the order of 2 meters, so as to suppress stimulated Raman scattering (SRS). In addition, to achieve efficient absorption of pump light 40 in core 50 over such short length D, cladding 46 is preferably small, e.g., between 100 μm and 200 μm in diameter. Furthermore, core 50 is preferably large, e.g., between 5 μm and 10 μm diameter, and exhibits a high doping level, e.g., 0.5% or more. A person skilled in the art will be able to select the appropriate dopant for doping core 50 to amplify primary beam 34 based on primary wavelength λₚ. Suitable doping ions when primary wavelength λₚ is in the green range are Ytterbium ions while Neodymium ions can be used for amplifying primary beam 34 when its light is in the green or blue range.

A lens 56 and a beam guiding element 58, in this case a mirror, are positioned in the path of pulsed intermediate beam 52. Lens 56 shapes pulsed intermediate beam 52 and element 58 deflects it such that beam 52 is in-coupled into a nonlinear element 60. Nonlinear element 60 is selected for its ability to frequency convert pulses 54 of pulsed intermediate beam 52 in a single pass to produce a pulsed output beam 62 at an output wavelength λₒᵤₜ. Only one pulse 64 of output beam 62 is illustrated for clarity.

In the present embodiment, nonlinear element 60 consists of a single nonlinear optical crystal capable of converting primary wavelength λₚ to output wavelength λₒᵤₜ in the UV, green or blue range. The conversion process is second harmonic generation (SHG) and is well-known in the art. SHG doubles the frequency of intermediate beam 52, or, equivalently, halves primary wavelength λₚ such that 2λₒᵤₜ=λₚ. Hence, when primary wavelength λₚ is in the range from 860 nm to 1100 nm output wavelength λₒᵤₜ will be in the range from 430 nm to 550 nm.

Preferably, optical crystal used as nonlinear element 60 is a borate crystal. In fact, preferably optical crystal is an LBO or BBO crystal. Also, although only one crystal is employed as nonlinear element 60 in the present embodiment, several can be used, as will be appreciated by those skilled in the art. In addition, any appropriate phase matching technique known in the art is employed to ensure efficient SHG in nonlinear element 60.

During operation, pump source 16 is tuned by mechanism 18 to generate pump light 20 in the form of a cw beam at the requisite wavelength to pump gain medium 30. Passively Q-switched laser 12 is adjusted such that primary pulses 36 of output beam 34 are controlled. To achieve this, one notes that a round-trip time, tᵣₜ, of cavity 26 is related to length L of cavity 26 by the equation:

$${t}_{rt} = \frac{2 L}{c} ,$$

where c is the speed of light. Hence, round-trip time tᵣₜ can be set by selecting length L of cavity 26. Meanwhile, passive Q-switch 32, in this case saturable absorber Q-switch is adjusted by setting its inter-pulse time. This is done by choosing the appropriate saturable loss, qₒ, of the absorbing material and using the fact that the repetition rate of passive Q-switch 32 is proportional to pump power or the power level of pump light 20, and that increasing the repetition rate produces longer primary pulses 36. A person skilled in the art will know how to adjust these parameters to obtain the appropriate inter-pulse time and will also find additional teachings provided by G. J. Spuhler et al., “Experimentally Confirmed Design Guidelines for Passively Q-Switched Microchip Lasers Using Semiconductor Saturable Absorbers”, J. Opt. Soc. Am. B, Vol. 16, No. 3, Mar. 1999, pp. 376-388 and other sources.

In a preferred embodiment, length L is very short, e.g., L is on the order of 10 millimeters or less. Preferably, L is even less than 1 millimeter. The inter-pulse time of passive Q-switch 32 is selected such that primary pulses 36 have a pulse duration tₚ of about 100 times round-trip time tᵣₜ as illustrated in FIG. 2. In addition, passive Q-switch 32 is also set such that the time between successive primary pulses 36 at times tᵢ and tᵢ₊₁ defining an interpulse separation is at least 100 times pulse time tₚ and preferably up to 10,000 times pulse time tₚ. Thus, in the preferred embodiment, primary pulses 36 have a duty cycle ranging from 0.01% to 1%.

Primary pulses 36 exiting passively Q-switched laser 12 should preferably have a peak power level of at least 10 Watts and preferably between 50 and 500 Watts. When primary pulses 36 enter fiber amplifier 14, which has a gain of about 100 or more (e.g., between 50 and 500) they are amplified to form intermediate pulses 54 with over 1,000 Watts and preferably over 10,000 Watts of peak power while preserving primary pulse timing as described above. At this power level and timing, intermediate pulses 54 have a pulse format which is above a nominal nonlinear frequency conversion threshold for SHG in nonlinear element 60. Specifically, for the purposes of this description, nominal nonlinear frequency conversion threshold is defined to correspond to a pulse conversion efficiency of at least 10%. Preferably, the conversion efficiency is close to 50% or even higher. Now, at 10,000 Watts of peak power intermediate pulses 54 exhibit approximately 50% efficient conversion to output pulses 64 in LBO or BBO crystals of 20 mm length.

By operating light source 10 as described above it is possible to obtain output beam 62 with output pulses 64 in the wavelength range from 430 nm to 550 nm at up to 5,000 Watts of peak power with a duty cycle between 0.01% and 1%. The actual application for which light source 10 is used will determine the exact peak power requirements for output pulses 64 and the required output wavelength λₒᵤₜ.

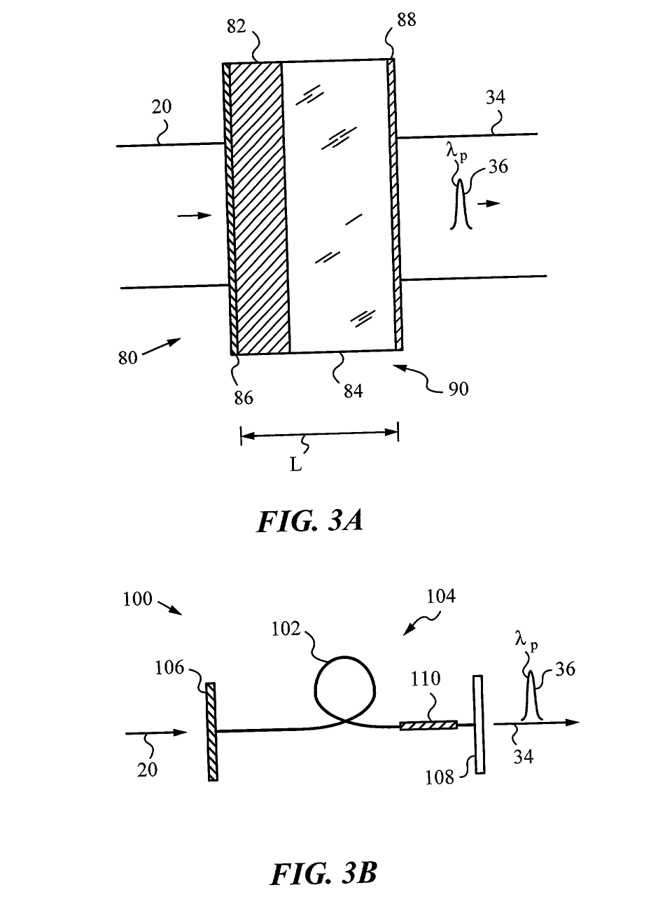

Light source 10 is a compound source with a number of elements requiring proper alignment and positioning. Several components of light source 10 can be simplified to reduce the complexity and cost of light source 10. FIG. 3A illustrates a preferred embodiment of a passively Q-switched laser 80 for light source 10. Laser 80 consists of a thin plate of saturable absorber 82 serving as the passive Q-switch and of a thin plate of gain medium 84. Saturable absorber 82 is bonded or otherwise attached to gain medium 84. It is also possible to align the plates of saturable absorber 82 and gain medium 84 in parallel and in close proximity. In this event the facing surfaces of the plates should be coated for low reflection.

A first mirror 86 and a second mirror 88 are deposited directly on the external surfaces of the plates of saturable absorber 82 and gain medium 84. First mirror 86 is an input coupler and admits pump light 20 into laser 80. Second mirror 88 is an output coupler, and serves for coupling out primary pulses 36 of pulsed primary beam 34. Mirrors 86 and 88 define a resonant cavity 90 of length L, which is short, e.g., on the order of 1 mm or less. Laser 80 is sometimes referred to as a microchip laser in the art. For further information on design guidelines for microchip lasers the reader is again referred to G. J. Spuhler et al., “Experimentally Confirmed Design Guidelines for Passively Q-Switched Microchip Lasers Using Semiconductor Saturable Absorbers”, J. Opt. Soc. Am. B, Vol. 16, No. 3, March 1999, pp. 376-388. FIG. 3B illustrates another embodiment of a passively Q-switched laser 100 for light source 10. Laser 100 has a gain fiber 102 disposed in a resonant cavity 104. Resonant cavity 104 is defined between a mirror 106 for in-coupling pump light and a mirror 108 for out-coupling pump beam 34. Although cavity 104 is defined by mirrors 106, 108 in this case, gratings or coatings placed near the end of gain fiber 102 could also be used to define cavity 104. In fact, sometimes only one grating or coating can be used and the other end of gain fiber 102 can be cleaved to obtain Fresnel reflection from the cleaved surface. A person skilled in the art will appreciate how to process gain fiber 102 to establish cavity 104.

Gain fiber 102 is doped with gain material, as is known in the art. A saturable loss absorber 110 serving as passive Q-switch is spliced with gain fiber 102. Alternatively, saturable loss absorber 110 can be a segment of fiber doped with the saturable absorber material or it can even be a separate segment of fiber placed between the end of gain fiber 102 and mirror 108.

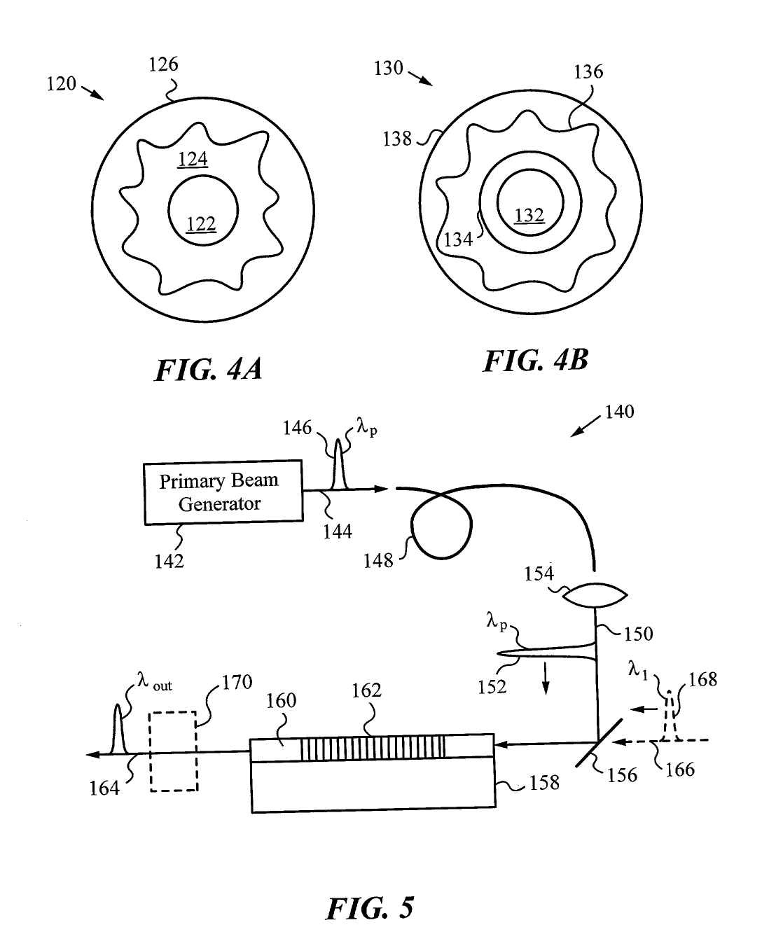

FIG. 4A illustrates in cross section a fiber amplifier 120 which can be used by light source 10. Fiber amplifier 120 has an active, circular core 122 surrounded by a cladding 124 with an irregular cross section. A protective outer cladding 126 surrounds cladding 124. Pump light 40 is in-coupled into cladding 124, while primary beam 34 is in-coupled into core 122, as described above. Because of the irregular cross section of cladding 124, pump light 40 is more efficiently delivered to core 122 for amplifying primary beam 34. Thus, the length of fiber amplifier 120 can be kept short, e.g., 2 meters or less, as indicated above.

FIG. 4B illustrates yet another fiber amplifier 130 which can be used by light source 10. Fiber amplifier 130 has an active, circular core 132 surrounded by a first cladding 134. Cladding 134 has a circular cross section and is in turn surrounded by a second cladding 136 with an irregular cross section. Fiber amplifier 130 has a protective outer cladding 138. The addition of cladding 134 and adjustment of its index of refraction makes it possible for fiber amplifier 130 to alter the propagation characteristics of fiber amplifier 130 to improve the in-coupling of pump light 40 into core 132 and to improve the amplification efficiency. Once again, this enables one to keep the length of fiber amplifier 130 short. A person skilled in the art will recognize that the appropriate choice of fiber amplifier, its cross section, its length as well as pulse time tₚ and pulse energy are required to avoid fiber optic nonlinearities and especially those associated with stimulated Raman scattering as well as stimulated Brillouin scattering (SBS) and self phase modulation.

FIG. 5 is a diagram of another embodiment of a light source 140 according to the invention. A primary beam generator 142 combines a pump source and a passively Q-switched laser and delivers a primary beam 144. Primary beam 144 consists of pulses 146 (only one indicated) of light at primary wavelength λₚ. Pulses 146 are formatted in accordance with the guidelines given above.

Primary beam 144 is delivered to a fiber amplifier 148. Fiber amplifier 148 amplifies primary beam 144 to produce an intermediate beam 150 still at primary wavelength λₚ. Intermediate beam 150 consists of pulses 152 (only one shown) which have a pulse duration, an inter-pulse separation and peak power defining a format calibrated to obtain at least 10% frequency conversion efficiency and preferably up to 50% or higher frequency conversion efficiency in a nonlinear element 158.

A lens 154 and a beam guiding element 156 are placed in the path of intermediate beam 150 for directing it to nonlinear element 158. Nonlinear element 158 has a waveguide 160 with a quasi-phase-matching (QPM) grating 162 disposed therein. QPM grating 162 is designed for phasematching the frequency conversion operation by which intermediate beam 150 is converted to an output beam 164 at output wavelength λₒᵤₜ. The frequency conversion operation producing output beam 164 is second harmonic generation (SHG). Conveniently, nonlinear element 158 with QPM grating 162 is a PPLN, PPLT, PPKTP, MgO:LN or other poled structure.

Alternatively, the frequency conversion operation can be optical parametric generation (OPG) or another type of nonlinear frequency conversion operation such as difference frequency generation (DFG). OPG is an alternative to SHG because it is a highly-efficient, single-pass and single input wavelength process (the requisite idler and signal beams are usually obtained by vacuum amplification). In addition, the output spectrum of output beam 164 is somewhat broadened (typically by a few nm) when OPG is used, making it more suitable for certain applications, e.g., for image displays. On the other hand, when DFG is used as the frequency conversion operation a beam 166 at wavelength λ₁ is required to mix with intermediate beam 150 in nonlinear element 158. In such situations pulses 168 (only one shown) of beam 166 should be synchronized with intermediate pulses 152. Also, beam guiding element 156 is then adapted to function as a beam combiner. Furthermore, a filter 170 can be provided for removing unwanted frequencies exiting nonlinear element 158.

Several frequency conversion processes, i.e., a cascaded nonlinear conversion process can be implemented in nonlinear element 158 and use beam 150 in conjunction with beam 166 (and/or other beams besides beam 166) or without it. Such operations may involve several nonlinear operations in series. For example, second harmonic generation followed by sum frequency generation, resulting in third harmonic generation.

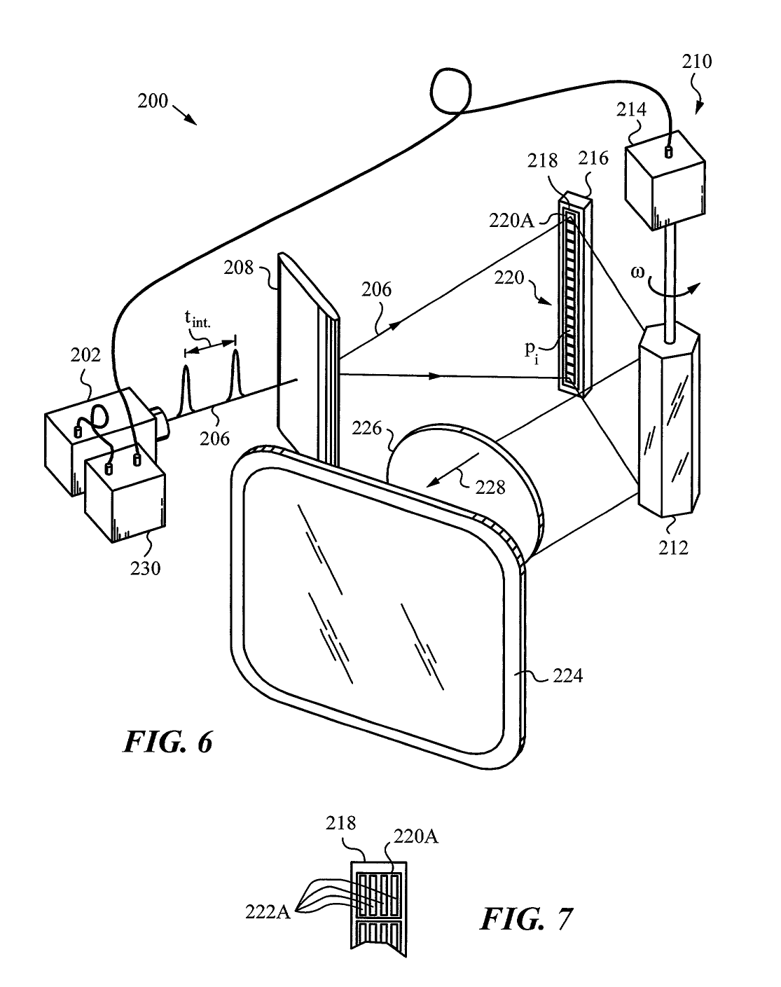

In a particularly convenient embodiment of the invention shown in FIG. 6 an image display system 200 employs a projection light source 202. In this case image display system 200 is a scanned linear image display system. Projection light source 202 has a first and a second light source (not shown in this figure) as described above for producing output in the green wavelength range and in the blue wavelength range, respectively. These two light sources are used one after the other or sequentially for a certain amount of time, as described below. Each of these two light sources is set to deliver an output beam 206 at an average power of 2.5 Watts. For this purpose the duty cycle of the intermediate beam is set at 0.05% and the peak power of intermediate pulses is set at 10,000 Watts. With this pulse format the conversion efficiency is about 50%. Hence, output beam 206 will have an average power of 2.5 Watts (5,000 Watts of peak power at 0.05% duty cycle).

It is convenient to also provide projection light source 202 with a third light source producing output in the red wavelength range. In this embodiment, the third light source is a diode laser producing 2.5 Watts average power at a red wavelength. The output of the third light source is coordinated with the output of the first and second sources, such that only one color is present in output beam 206 at a time.

Image projection system 200 has cylindrical beam shaping and guiding optics 208, generally indicated by a cylindrical lens. Of course, guiding optics 208 will typically include a number of lenses and other elements, as will be appreciated by a person skilled in the art. Optics 208 are adapted for line-wise image scanning by expanding output beam 206 along the vertical direction. An image generator 216 having a vertical line 218 of pixels pᵢ is positioned in the path of expanded output beam 206. Image generator 216 can be any suitable unit capable of generating images line-by-line and requiring illumination by red, green and blue wavelengths in succession, as provided in output beam 206. In the present embodiment image generator 216 is a grating light valve array made up of vertical line 218 of independently controlled grating-type light valves 220. Each one of light valves 220 corresponds to a pixel. FIG. 7 illustrates a light valve 220A having adjustable grating strips 222A. Strips 222A are moved by a suitable mechanism to adjust the grating of light valve 220A to diffract a particular color into a projection beam 228. The principles of operation and design of grating-type light valves are known and the reader is referred for further information to David T. Amm et al., “Optical Performance of the Grating Light Valve Technology”, presented at Photonics West—Electronic Imaging 1999, Projection Displays.

A linear scanner 210 having a rotating deflection unit 212 and a control 214 is provided for line-wise scanning of projection beam 228. The scanning speed is controlled by control unit 214 which adjusts the angular speed of rotation ω of deflecting unit 212. A person skilled in the art will recognize that other types of optics and scanning devices can be used, depending on the method of image scanning.

The scanned image produced by image generator 216 is projected on a display screen 224 with the aid of optics 226, generally indicated by a lens. In particular, light valves 220, are set to diffract red, green and blue wavelengths provided in beam 206 to generate an image linewise in the diffracted projection beam 228. Beam 228 is projected by optics 226 on screen 224 to display the image to a viewer. In one implementation certain light valves 220 are dedicated to each color.

Preferably, in this case valves 220 are subdivided into groups of three one for diffracting blue, another for diffracting green and a third one for diffracting red into projection beam 228. Alternatively, light valves 220 can be modulated to diffract different colors at different times (e.g., by time-multiplexing).

A synchronizing mechanism 230 is connected to projection light source 202 and to control 214 of linear scanner 210. Mechanism 230 is provided to coordinate the timing of output pulses 232 in output beam 206 with the line scanning performed by linear scanner 210.

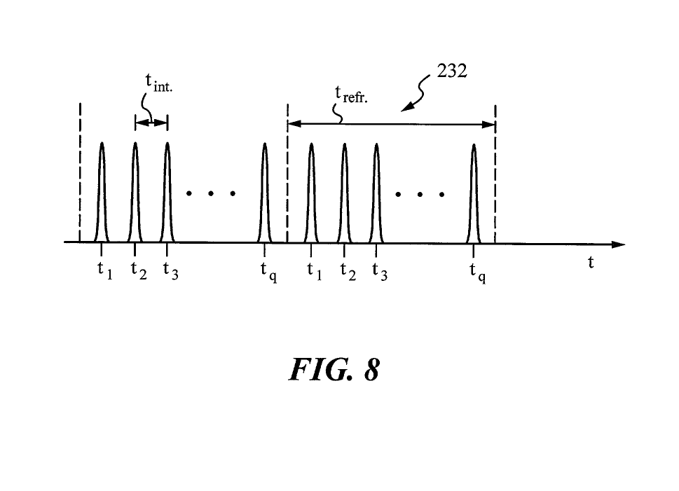

When operating image display system 200 projection light source 202 is set to deliver output pulses 232 at the green wavelength from light source one, at the blue wavelength from light source two, and at the red wavelength from light source three. The pulses are repeated at a certain rate (i.e., at the inter-pulse rate set as described above). Specifically, as better illustrated in FIG. 7, light source 202 is set to deliver a number q of pulses 232 during a refresh time t_{refr.} which is the time allotted by control 214 of linear scanner 210 to generating each line of the image. Preferably, the number of pulses 232 during refresh time t_{refr.} should be an integer multiple of the refresh rate, e.g., 6 or more pulses 232 per refresh time t_{refr.} (i.e., q=6). For better visualization, FIG. 8 illustrates the q pulses 232 delivered by projection light source 202 during each refresh time t_{refr.}.

The number q is dictated by the angular velocity ω of rotating deflection unit 212. Synchronizing mechanism 230 adjusts the timing of output pulses 232 in coordination with angular velocity ω of unit 212 such that number q of pulses 232 delivered during each refresh time t_{refr.} is equal. Refresh time t_{refr.} is dictated, among other, by the perception parameters of the human eye. Pixels pi in each line 218 have to be refreshed rapidly enough for the human eye not to notice any appreciable image discontinuities. This condition determines the length of refresh time t_{refr.} given the number of lines of which the scanned image is composed.

In display systems with a large number of lines, e.g., on the order of 1,000 to 2,000 the appropriate refresh rate requires that passively Q-switched laser for the first and second light sources (green and blue) be set at a primary pulse repetition rate of at least 100 kHz.

The light source of the invention can also be used in image displays which are not scanned line-by-line but employ some different scanning procedure. It can also be used in display systems using as image generating pixels liquid crystals or micro-mirror arrays. In still another embodiment, the light source of invention can be used to illuminate a two-dimensional array of pixels generating an image in a non-scanned image display system. A person skilled in the art will appreciate that various multiplexing and scanning methods can be employed to operate such scanned and non-scanned display systems. Additionally, a person skilled in the art will recognize that the applications of the light source in a display system is only one of the many applications for this light source can be used.

Although the present invention and its advantages have been described in detail, it should be understood that various changes, substitutions, and alterations can be made herein without departing from the principle and the scope of the invention. Accordingly, the scope of the present invention should be determined by the following claims and their legal equivalents.

What is claimed is:

1. A light source comprising:
a) a passively Q-switched laser for delivering a pulsed primary beam at a primary wavelength;
b) a fiber amplifier for receiving said primary beam and amplifying said primary beam to produce a pulsed intermediate beam of intermediate pulses at said primary wavelength, said intermediate pulses having a format calibrated for a predetermined frequency conversion efficiency; and
C) a nonlinear element for frequency converting said pulsed intermediate beam in a single pass at said predetermined frequency conversion efficiency to produce a pulsed output beam at an output wavelength.

2. The light source of claim 1, wherein said primary wavelength ranges from 860 nm to 1100 nm.

3. The light source of claim 1, wherein said output wavelength ranges from 430 nm to 550 nm.

4. The light source of claim 1, wherein said fiber amplifier is a cladding-pumped amplifier.

5. The light source of claim 4, wherein said cladding-pumped amplifier has a predetermined core section and a predetermined cladding section.

6. The light source of claim 4, wherein said cladding-pumped amplifier has a length of less than 2 m.

7. The light source of claim 1, wherein said passively Q-switched laser comprises a saturable absorber Q-switch.

8. The light source of claim 7, wherein said saturable absorber Q-switch is set such that said pulsed primary beam comprises primary pulses with a duty cycle ranging from 0.01% to 1%.

9. The light source of claim 7, wherein said saturable absorber Q-switch is set such that said pulsed primary beam comprises primary pulses having a pulse width and having an interpulse separation of at least 100 times said pulse width.

10. The light source of claim 7, wherein said saturable absorber Q-switch is set to operate said passively Q-switched laser at a primary pulse repetition rate of at least 100 kHz.

11. The light source of claim 1, wherein said nonlinear element comprises at least one nonlinear optical crystal.

12. The light source of claim 11, wherein said at least one nonlinear optical crystal comprises a borate.

13. The light source of claim 12, wherein said borate is selected from the group consisting of LBO and BBO.

14. The light source of claim 1, wherein said predetermined conversion efficiency is at least 10%.

15. The light source of claim 14, wherein said predetermined conversion efficiency is about 50%.

16. A display system having a light source comprising:
a) a passively Q-switched laser for delivering a pulsed primary beam at a primary wavelength;
b) a fiber amplifier for receiving said primary beam and amplifying said primary beam to produce a pulsed intermediate beam with intermediate pulses at said primary wavelength said intermediate pulses having a format corresponding to a predetermined frequency conversion efficiency; and
c) a nonlinear element for frequency converting said pulsed intermediate beam in a single pass at said predetermined conversion efficiency to produce a pulsed output beam at an output wavelength.

17. The display system of claim 16, further comprising:
a) a plurality of display pixels being refreshed at a refresh rate;
b) a synchronizing mechanism for synchronizing output pulses of said pulsed output beam with said refresh rate.

18. The display system of claim 17, wherein said synchronizing mechanism synchronizes said pulses at an integer multiple of said refresh rate.

19. The display system of claim 16, wherein said primary wavelength ranges from 860 nm to 1100 nm.

20. The display system of claim 16, wherein said output wavelength ranges from 430 nm to 550 nm.

21. The display system of claim 16, wherein said fiber amplifier is a cladding-pumped amplifier.

22. The display system of claim 21, wherein said cladding-pumped amplifier has a predetermined core section and a predetermined cladding section.

23. The display system of claim 21, wherein said cladding-pumped amplifier has a length of less than 2 m.

24. The display system of claim 16, wherein said passively Q-switched laser comprises a saturable absorber Q-switch.

25. The display system of claim 24, wherein said saturable absorber Q-switch is set such that said pulsed primary beam comprises primary pulses with a duty cycle ranging from 0.01% to 1%.

26. The display system of claim 24, wherein said saturable absorber Q-switch is set such that said pulsed primary beam comprises primary pulses having a pulse width and an interpulse separation of at least 100 times said pulse width.

27. The display system of claim 24, wherein said saturable absorber Q-switch is set to operate said passively Q-switched laser at a primary pulse repetition rate of at least 100 kHz.

28. The display system of claim 16, wherein said nonlinear element comprises at least one nonlinear optical crystal.

29. The display system of claim 28, wherein said at least one nonlinear optical crystal comprises a borate.

30. The display system of claim 29, wherein said borate is selected from the group consisting of LBO and BBO.

31. The display system of claim 16, wherein said predetermined conversion efficiency is at least 10%.

32. The display system of claim 31, wherein said predetermined conversion efficiency is about 50%.
